(19) United States
(12) Patent Application Publication
(10) Pub. No.: US 2026/0155391 A1
(43) Pub. Date: Jun. 4, 2026

(54) POWER STORAGE CELL AND MANUFACTURING METHOD THEREOF

(71) Applicants: TOYOTA JIDOSHA KABUSHIKI KAISHA, Toyota-shi (JP); TOYOTA BATTERY CO., LTD., Kosai-shi (JP)

(72) Inventors: Yasuaki NAGANO, Kosai-shi (JP); Yosuke SHIMURA, Nagakute-shi (JP); Satoshi NAKASHIMA, Toyota-shi (JP); Kenichi KAKISHITA, Nagoya-shi (JP); Masashi CHIHARA, Nagoya-shi (JP); Hiroki AWANO, Susono-shi (JP); Masaya OGURA, Hamamatsu-shi (JP); Ryosuke SATO, Toyota-shi (JP)

(73) Assignees: TOYOTA JIDOSHA KABUSHIKI KAISHA, Toyota-shi (JP); TOYOTA BATTERY CO., LTD., Kosai-shi (JP)

(21) Appl. No.: 19/381,444

(22) Filed: Nov. 6, 2025

(30) Foreign Application Priority Data
Nov. 29, 2024 (JP) 2024-208765

(51) Int. Cl. H01M 4/66; H01M 4/02; H01M 4/80; H01M 10/04

(52) U.S. Cl. CPC H01M 4/667; H01M 4/661; H01M 4/803; H01M 10/0431; H01M 2004/021

(57) ABSTRACT

The power storage cell includes an electrode assembly and a case that houses the electrode assembly. The electrode assembly includes a first electrode. The first electrode includes an insulating support layer, and a first conductive layer and a second conductive layer that is formed on the insulating support layer. Each of the first conductive layer and the second conductive layer is formed of flaky metal powder.

### CROSS REFERENCE TO RELATED APPLICATIONS

This non-provisional application is based on Japanese Patent Application No. 2024-208765 filed on Nov. 29, 2024 with the Japan Patent Office, the entire contents of which are hereby incorporated by reference.

### BACKGROUND

### Field

The present disclosure relates to a power storage cell and a manufacturing method of the power storage cell.

### Description of the Background Art

Japanese Patent Application Laying-Open No. 2020-198290 discloses a power storage cell equipped with a composite current collector that includes an organic support layer and a conductive layer disposed on the organic support layer.

### SUMMARY

In Japanese Patent Application Laying-Open No. 2020-198290, when the organic support layer (insulating support layer) is bent, the conductive layer may not be flexible enough to follow the organic support layer. Specifically, when the conductive layer is bent together with the organic support layer, since a gap is generated between metal particles constituting the conductive layer, a crack may be formed on the conductive layer. Thus, the organic support layer is exposed from the crack. Therefore, gas may permeate into the exposed organic support layer, which causes the organic support layer to expand or contract.

The present disclosure has been made to solve the aforementioned problems, and an object of the present disclosure is to provide a power storage cell and a method manufacturing of a power storage cell capable of preventing an insulating support layer from being exposed from a crack formed on a conductive layer stacked on the insulating support layer.

A power storage cell according to a first aspect of the present disclosure includes an electrode assembly and a container that houses the electrode assembly. The electrode assembly includes an electrode sheet. The electrode sheet includes an insulating support layer and a conductive layer that is formed on the insulating support layer. The conductive layer is formed of flaky metal powder.

A method manufacturing of a power storage cell according to a second aspect of the present disclosure includes forming an electrode assembly and housing the electrode assembly in a container. The forming of the electrode assembly includes preparing an insulating support layer and forming a conductive layer by stacking flaky metal powder on the insulating support layer.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a perspective view illustrating a power storage device and a frame member according to the present embodiment.

FIG. 2 is a perspective view illustrating a power storage cell according to the present embodiment.

FIG. 3 is an exploded perspective view illustrating a power storage cell according to the present embodiment.

FIG. 4 is a cross-sectional view illustrating an electrode assembly.

FIG. 5 is a partially enlarged cross-sectional view illustrating a first electrode and a first tab.

FIG. 6 is a schematic plan view illustrating a first conductive layer.

FIG. 7 is a schematic cross-sectional view illustrating a first conductive layer and an insulating support layer.

FIG. 8 is a flowchart illustrating a manufacturing method of the power storage cell according to the present embodiment.

FIG. 9 is a diagram illustrating a step of forming a first conductive layer and a second conductive layer on an insulating support layer.

FIG. 10 is a view illustrating coating particles.

FIG. 11 is a schematic cross-sectional view illustrating a conductive layer and an insulating support layer according to a first modification of the present embodiment.

FIG. 12 is a schematic cross-sectional view illustrating a conductive layer and an insulating support layer according to a second modification of the present embodiment.

### DESCRIPTION OF THE PREFERRED EMBODIMENTS

Hereinafter, an embodiment of the present disclosure will be described in detail with reference to the drawings. It should be noted that in the following description of the present embodiment, the same or equivalent members in the drawings will be denoted by the same reference numerals, and the description thereof will not be repeated.

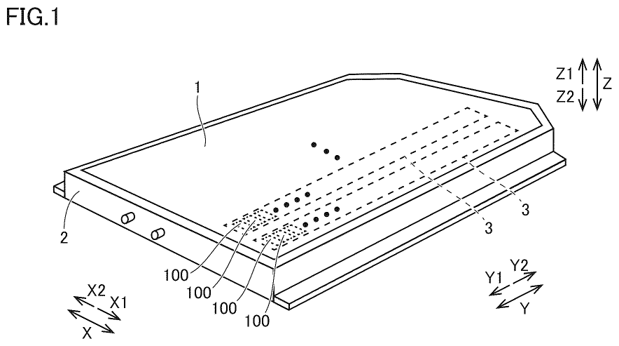

FIG. 1 is a perspective view illustrating a power storage device 1 that includes a power storage cell 100 according to an embodiment of the present disclosure. Power storage device 1 is mounted on, for example, a vehicle (not shown). Examples of the vehicle include a hybrid electric vehicle (HEV), a plug-in hybrid electric vehicle (PHEV), and a battery electric vehicle (BEV). Power storage device 1 may be provided in an electric device (for example, a stationary power storage device) other than an electric vehicle.

Note that an X direction, a Y direction and a Z direction in the present specification are directions orthogonal to each other. For example, when power storage device 1 is mounted on an electric vehicle, the X direction and the Y direction may be the front-rear direction and the left-right direction, respectively. The Z direction may be the upward-downward direction. Specifically, the Z1 direction and the Z2 direction may be the upward direction and the downward direction, respectively.

Power storage device 1 is attached to a frame member 2 on the bottom of the vehicle. Frame member 2 is formed in a substantially quadrangular cylindrical shape surrounding power storage device 1.

Power storage device 1 includes a plurality of power storage stacks 3. Each power storage stack 3 is formed in a rectangular parallelepiped shape longer in the Y direction. The plurality of power storage stacks 3 are arranged side by side in the X direction. Each power storage stack 3 includes a plurality of power storage cells 100 arranged in the Y direction. For simplification, FIG. 1 only illustrates two power storage stacks 3 and three power storage cells 100 in each power storage stack 3.

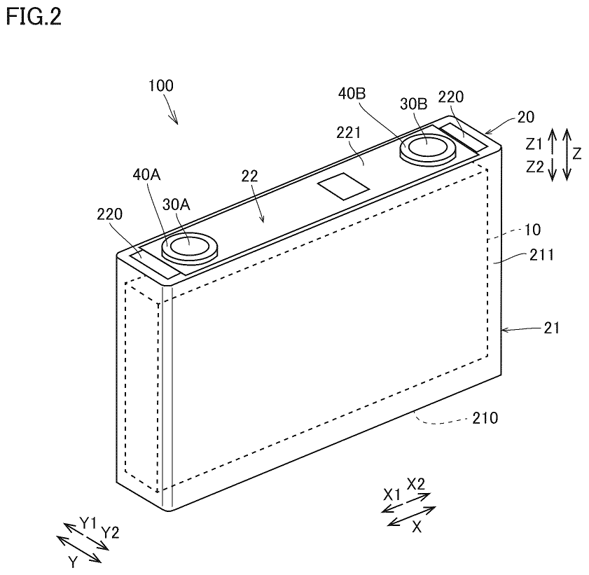

FIG. 2 is a perspective view illustrating power storage cell 100 according to the present embodiment. As illustrated in FIG. 2, power storage cell 100 is a so-called square battery. Power storage cell 100 is a chargeable/dischargeable secondary battery. Power storage cell 100 may be a secondary battery such as a lithium ion battery or a nickel metal hydride battery. Power storage cell 100 may be used, for example, as a storage cell included in a power storage module mounted on an electric vehicle.

Power storage cell 100 includes an electrode assembly 10, a case 20, a first external terminal 30A, a second external terminal 30B, a first terminal support member 40A, and a second terminal support member 40B. In FIG. 2, electrode assembly 10 is schematically denoted by a broken line.

Case 20 is electrically conductive. The conductive portion of case 20 is made of a metal such as aluminum. Case 20 houses electrode assembly 10. Case 20 also houses an electrolyte (not shown). Case 20 is an example of a “container” of the present disclosure.

Case 20 includes a case body 21 and a lid 22. Case body 21 includes a bottom wall 210 and a peripheral wall 211 rising from bottom wall 210.

Lid 22 includes a lid body 220 and an insulating cover 221. Lid body 220 is joined to peripheral wall 211 by welding or the like so as to close an opening formed by peripheral wall 211.

First external terminal 30A and second external terminal 30B are provided so as to be exposed to the outside of power storage cell 100. In the present embodiment, first external terminal 30A is a positive electrode terminal, and second external terminal 30B is a negative electrode terminal. First external terminal 30A and second external terminal 30B are arranged side by side in the X direction.

First terminal support member 40A is fixed on lid body 220. First terminal support member 40A supports first external terminal 30A by supporting an outer surface of first external terminal 30A. Second terminal support member 40B is fixed on lid body 220. Second terminal support member 40B supports second external terminal 30B by supporting an outer surface of second external terminal 30B.

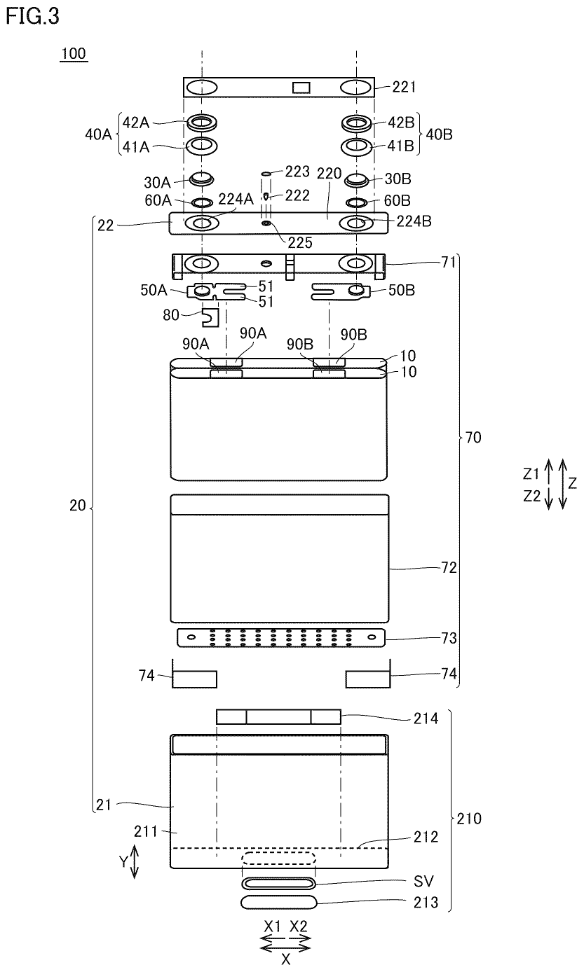

FIG. 3 is an exploded perspective view illustrating power storage cell 100 according to the present embodiment. Power storage cell 100 further includes a first connection member 50A, a second connection member 50B, a first sealing ring 60A, a second sealing ring 60B, an insulating member 70, and a fuse protection member 80.

Bottom wall 210 includes a bottom body 212, an outer protective film 213, and an inner protective film 214. Peripheral wall 211 rises from bottom body 212. Bottom body 212 is provided with a pressure release valve SV. Outer protective film 213 covers an outer surface of pressure release valve SV. Inner protective film 214 covers an inner surface of pressure release valve SV. Bottom body 212 and pressure release valve SV are made of a metal such as aluminum.

An opening is formed in an upper end of peripheral wall 211. Peripheral wall 211 has a substantially rectangular outer shape when viewed from the opening direction of the opening. The opening and bottom wall 210 are arranged in the Z direction. The opening is formed on the Z1 side of bottom wall 210. The Z direction may be a height direction or a vertical direction of power storage cell 100. Peripheral wall 211 is made of a metal such as aluminum.

Lid 22 further includes a sealing plug 222 and a plug cover 223. Lid body 220 is formed with a first connection hole 224A, a second connection hole 224B, and a liquid injection hole 225. Liquid injection hole 225 is a through hole for injecting an electrolytic solution into case body 21 in the manufacturing process of power storage cell 100.

Sealing plug 222 seals liquid injection hole 225. Plug cover 223 covers liquid injection hole 225 and sealing plug 222. Insulating cover 221 covers liquid injection hole 225, sealing plug 222 and plug cover 223.

First connection member 50A and second connection member 50B are electrically conductive. At least a part of first connection member 50A and second connection member 50B is disposed inside case 20. Each of first connection member 50A and second connection member 50B is disposed at a position facing electrode assembly 10 in the Z direction. Each of first connection member 50A and second connection member 50B is formed on the side of electrode assembly 10 in the Z1 direction.

First external terminal 30A or first connection member 50A is inserted into first connection hole 224A. First external terminal 30A is connected to first connection member 50A. First connection member 50A is connected to electrode assembly 10. Thus, first external terminal 30A is electrically connected to electrode assembly 10.

Second external terminal 30B or second connection member 50B is inserted into second connection hole 224B. Second external terminal 30B is connected to second connection member 50B. Second connection member 50B is connected to electrode assembly 10. Thus, second external terminal 30B is electrically connected to electrode assembly 10.

First sealing ring 60A is disposed along first connection hole 224A. First sealing ring 60A is disposed between lid body 220 and first external terminal 30A to seal a gap therebetween. Second sealing ring 60B is disposed along second connection hole 224B. Second sealing ring 60B is disposed between lid body 220 and second external terminal 30B to seal a gap therebetween. First sealing ring 60A and second sealing ring 60B are electrically insulating.

First terminal support member 40A includes a first engaging ring 41A and a first covering ring 42A. First engaging ring 41A extends annularly so as to surround first connection hole 224A, and is directly engaged with lid body 220. First covering ring 42A covers first engaging ring 41A. First engaging ring 41A supports first external terminal 30A via first covering ring 42A. First covering ring 42A is made of an electrically insulating or relatively weakly conductive resin composition.

Second terminal support member 40B includes a second engaging ring 41B and a second covering ring 42B. Second engaging ring 41B extends annularly so as to surround second connection hole 224B, and is directly engaged with lid body 220. Second covering ring 42B covers second engaging ring 41B. Second engaging ring 41B supports second external terminal 30B via second covering ring 42B. Second covering ring 42B is made of an electrically insulating resin composition.

Insulating member 70 is electrically insulating. Insulating member 70 is disposed between electrode assembly 10 and case 20. Insulating member 70 electrically insulates electrode assembly 10 and case 20 from each other. Insulating member 70 includes an insulating bracket 71, a peripheral insulating member 72, a bottom insulating member 73, and an adhesive tape 74.

Insulating bracket 71 is disposed between electrode assembly 10 and lid body 220. Insulating bracket 71 is relatively rigid, and is in contact with both electrode assembly 10 and lid body 220. Thus, electrode assembly 10 is fixed to case 20 in the Z direction.

Peripheral insulating member 72 is disposed between electrode assembly 10 and peripheral wall 211. Peripheral insulating member 72 is formed of a film member.

Bottom insulating member 73 is disposed between electrode assembly 10 and bottom wall 210. Bottom insulating member 73 is formed of a film member. Bottom insulating member 73 is fixed (adhered) to case 20 (bottom wall 210) by adhesive tape 74.

Power storage cell 100 according to the present embodiment includes a plurality of electrode assemblies 10. Power storage cell 100 according to the present embodiment includes two electrode assemblies 10. The plurality of electrode assemblies 10 are arranged side by side in the Y direction. Peripheral insulating member 72 is configured to integrally cover the plurality of electrode assemblies 10 so as to fix the plurality of electrode assemblies 10 to each other.

Each of the plurality of electrode assemblies 10 is provided with at least one first tab 90A and at least one second tab 90B. In the present embodiment, each of the plurality of electrode assemblies 10 is provided with a plurality of first tabs 90A and a plurality of second tabs 90B. Each first tab 90A electrically connects a first electrode 10A (which will be described later) and first connection member 50A. Each second tab 90B electrically connects a second electrode 10B (which will be described later) and second connection member 50B.

The plurality of first tabs 90A are arranged side by side in the Y direction. The plurality of first tabs 90A are joined to each other by ultrasonic welding, for example. The plurality of first tabs 90A are joined to first connection member 50A by ultrasonic welding, for example. The plurality of second tabs 90B are arranged side by side in the Y direction. The plurality of second tabs 90B are joined to each other by ultrasonic welding, for example. The plurality of second tabs 90B are joined to second connection member 50B by ultrasonic welding, for example.

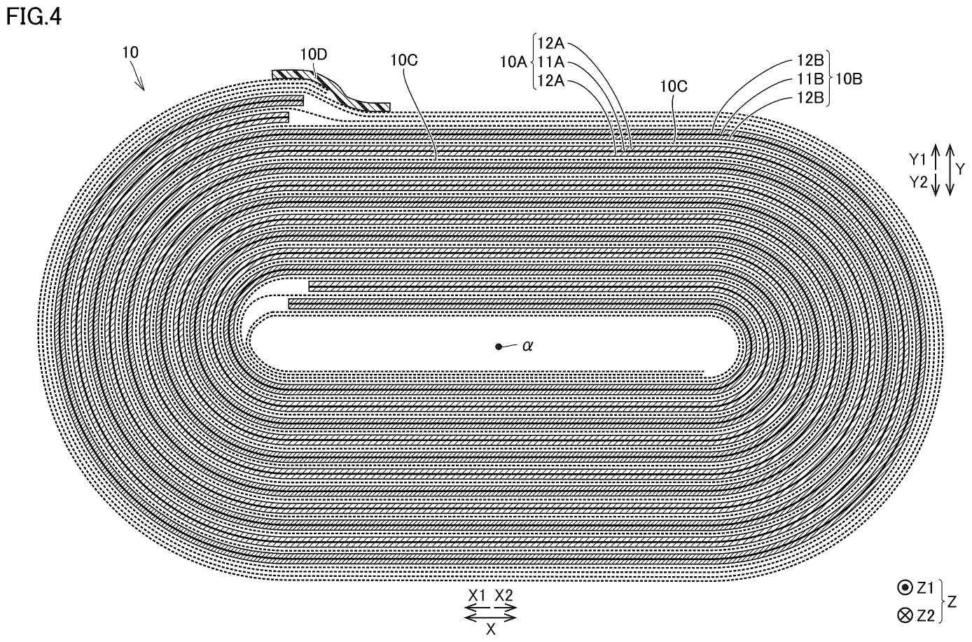

FIG. 4 is a cross-sectional view illustrating electrode assembly 10 along the XY plane. Electrode assembly 10 includes a first electrode 10A, a second electrode 10B, a separator 10C, and a tape member 10D. Electrode assembly 10 is obtained by winding first electrode 10A, second electrode 10B and separator 10C around a winding axis α. As described above, in the present embodiment, electrode assembly 10 is a so-called wound-type electrode assembly, but may be a stacked electrode assembly in which first electrode 10A, second electrode 10B and separator 10C are stacked in one direction (for example, the Y direction). First electrode 10A is an example of an “electrode sheet” in the present disclosure.

First electrode 10A and second electrode 10B each have a sheet shape. Electrode assembly 10 is formed of a group of electrode plates obtained by winding first electrode 10A and second electrode 10B with one or more separators 10C interposed therebetween.

In the present embodiment, first electrode 10A is a positive electrode, and second electrode 10B is a negative electrode. However, first electrode 10A may be configured as a negative electrode, and second electrode 10B may be configured as a positive electrode.

Separator 10C is disposed between first electrode 10A and second electrode 10B. Separator 10C separates first electrode 10A and second electrode 10B while allowing ions to move between first electrode 10A and second electrode 10B. The ions are, for example, lithium ions. Separator 10C is electrically insulating.

Among first electrode 10A, second electrode 10B and separator 10C, separator 10C is disposed on the innermost position with respect to winding axis α. Alternatively, among first electrode 10A, second electrode 10B and separator 10C, separator 10C may be disposed on the outermost position with respect to winding axis α. The outer edge of separator 10C in the winding direction is fixed by tape member 10D disposed on the outer surface of separator 10C.

First electrode 10A includes a first current collector 11A and a first active material layer 12A. Second electrode 10B includes a second current collector 11B and a second active material layer 12B.

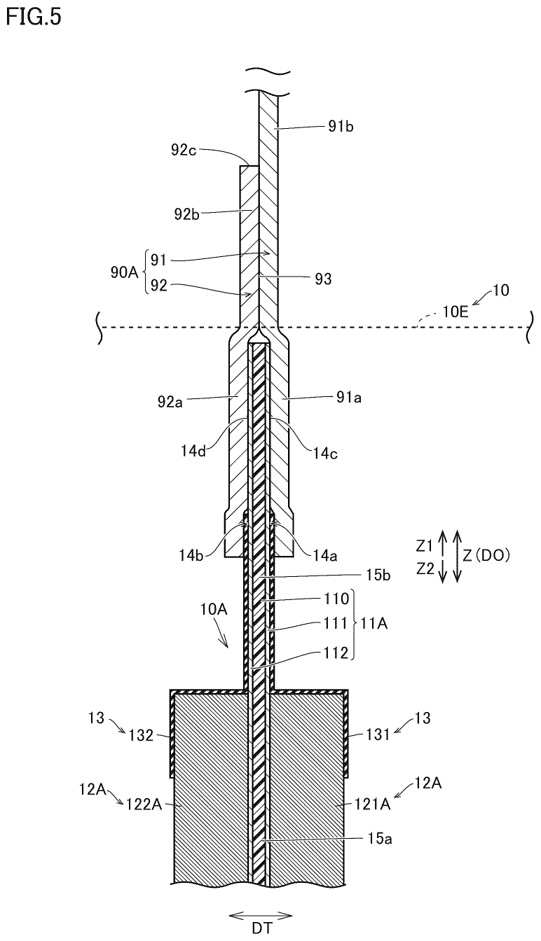

FIG. 5 is a cross-sectional view of first electrode 10A and first tab 90A. First current collector 11A includes an insulating support layer 110, a first conductive layer 111, and a second conductive layer 112. First electrode 10A further includes a protective member 13. Each of first conductive layer 111 and second conductive layer 112 is an example of a “conductive layer” in the present disclosure.

Insulating support layer 110 is made of an electrically insulating resin composition. For example, insulating support layer 110 is made of a resin composition that contains polyester resin. The polyester resin is preferably polyethylene terephthalate, for example. This makes it possible to increase the rigidity of first current collector 11A while maintaining the electrical insulation property of insulating support layer 110. Thus, insulating support layer 110 can be made relatively thin. An orthogonal direction DO, which is orthogonal to a thickness direction DT of insulating support layer 110, is substantially parallel to the Z direction. The material of insulating support layer 110 is not limited to those mentioned above. For example, insulating support layer 110 may be made of fabric or paper.

First conductive layer 111 is formed on (is in contact with) insulating support layer 110 at one side in the thickness direction DT. First conductive layer 111 is disposed at a position closer to winding axis α (in other words, the inner side) when viewed from insulating support layer 110. In addition, first conductive layer 111 is provided over the entire surface of a coated portion 15a and an uncoated portion 15b, which will be described later, at one side in the thickness direction DT.

Second conductive layer 112 is formed on (is in contact with) insulating support layer 110 at the other side in the thickness direction DT. Second conductive layer 112 is disposed on the opposite side of winding axis α (in other words, the outer side) when viewed from insulating support layer 110. Second conductive layer 112 is provided over the entire surface of a coated portion 15a and an uncoated portion 15b, which will be described later, at the other side in the thickness direction DT.

Each of first conductive layer 111 and second conductive layer 112 is made of a metal. Each of first conductive layer 111 and second conductive layer 112 is made of a metal that contains aluminum. Thus, first current collector 11A may be suitably used as a positive electrode current collector. First current collector 11A may be a negative electrode current collector, and first conductive layer 111 and second conductive layer 112 may be made of a metal that contains copper.

Each of the plurality of first tabs 90A is joined to first conductive layer 111 and second conductive layer 112 by ultrasonic welding, for example. Each of the plurality of first tabs 90A extends from insulating support layer 110 in the Z1 direction.

First current collector 11A has a surface 14a and a surface 14b arranged in the thickness direction DT. Surface 14a is a surface of first conductive layer 111 opposite to insulating support layer 110. Surface 14b is a surface of second conductive layer 112 opposite to insulating support layer 110.

First current collector 11A includes a coated portion 15a which is coated with first active material layer 12A and an uncoated portion 15b which is not coated with first active material layer 12A. First current collector 11A is exposed from at least a part of uncoated portion 15b. Uncoated portion 15b is provided on the side of coated portion 15a in the Z1 direction (toward first connection member 50A (FIG. 3)). First active material layer 12A coated on coated portion 15a covers each of surface 14a and surface 14b of first current collector 11A.

Each of the plurality of first tabs 90A includes a first foil 91 and a second foil 92. First foil 91 is located on one side of first conductive layer 111 opposite to insulating support layer 110. First foil 91 is joined to first conductive layer 111. First foil 91 is joined to first connection member 50A (FIG. 3). Second foil 92 is located on one side of second conductive layer 112 opposite to insulating support layer 110. Second foil 92 is joined to second conductive layer 112.

First foil 91 is provided on a portion 14c of surface 14a corresponding to uncoated portion 15b. First foil 91 is joined to portion 14c.

Second foil 92 is provided on a portion 14d of surface 14b corresponding to uncoated portion 15b. Second foil 92 is joined to portion 14d. Portion 14d is provided in a region overlapping with portion 14c in the Z direction.

First foil 91 includes a lower foil portion 91a and an upper foil portion 91b. Lower foil portion 91a is disposed on first electrode 10A. Specifically, lower foil portion 91a is joined to portion 14c. Upper foil portion 91b protrudes from lower foil portion 91a (portion 14c) in the Z1 direction (toward first connection member 50A (FIG. 3)).

Second foil 92 includes a lower foil portion 92a and an upper foil portion 92b. Lower foil portion 92a is disposed on first electrode 10A. Specifically, lower foil portion 92a is joined to portion 14d. Upper foil portion 92b protrudes from lower foil portion 92a (portion 14d) in the Z1 direction (toward first connection member 50A (FIG. 3)).

Upper foil portion 91b is joined to upper foil portion 92b. Specifically, upper foil portion 91b is joined to upper foil portion 92b by ultrasonic welding, for example, at a joint portion 93 away from first current collector 11A in the Z1 direction.

First foil 91 (upper foil portion 91b) extends in the Z1 direction further than an upper end 92c (upper end in the Z1 direction) of second foil 92 (upper foil portion 92b). Joint portion 93 is a portion where upper foil portion 92b and a root portion of upper foil portion 91b in the Z2 direction are joined to each other. Joint portion 93 extends, for example, from an upper end 10E of electrode assembly 10 in the Z1 direction. Upper end 10E of electrode assembly 10 is an upper end of separator 10C (FIG. 4). The lower end of joint portion 93 may be located on one side of upper end 10E in the Z1 direction or in the Z2 direction, for example.

As described above, the length of first foil 91 in the orthogonal direction DO (Z direction) orthogonal to the thickness direction DT is longer than the length of second foil 92 in the orthogonal direction DO. However, first tab 90A is not limited thereto. The length of second foil 92 in the orthogonal direction DO may be longer than the length of first foil 91 in the orthogonal direction DO. Second foil 92 may be joined to first connection member 50A, and first foil 91 may not be joined to first connection member 50A.

First active material layer 12A includes an inner active material layer 121A and an outer active material layer 122A. Inner active material layer 121A is stacked on first conductive layer 111. Outer active material layer 122A is stacked on second conductive layer 112.

An upper end of first active material layer 12A is separated from each of the plurality of first tabs 90A. Specifically, the upper end of inner active material layer 121A is separated from first foil 91 of each of the plurality of first tabs 90A. An upper end of outer active material layer 122A is separated from second foil 92 of each of the plurality of first tabs 90A.

Separator 10C is stacked on first active material layer 12A in the radial direction of winding axis α (FIG. 4). Separator 10C is stacked on inner active material layer 121A in the radial direction. Separator 10C is also stacked on outer active material layer 122A in the radial direction.

Protective member 13 is electrically insulating, and is made of ceramic, for example. Protective member 13 covers an upper portion of first active material layer 12A. Protective member 13 further covers first current collector 11A located between first tab 90A and first active material layer 12A.

Protective member 13 includes an inner protective member 131 and an outer protective member 132. Inner protective member 131 covers an upper portion of inner active material layer 121A. Inner protective member 131 covers first conductive layer 111 located between first foil 91 and inner active material layer 121A. Outer protective member 132 covers an upper portion of outer active material layer 122A. Outer protective member 132 covers second conductive layer 112 located between second foil 92 and outer active material layer 122A.

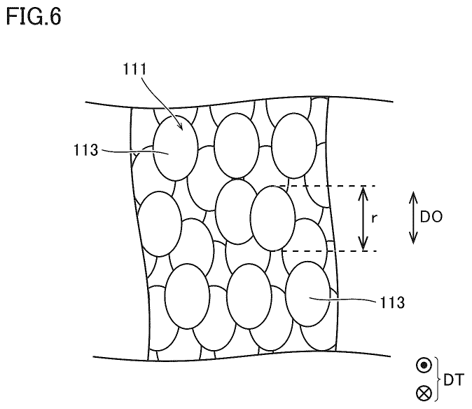

FIG. 6 is a plan view schematically illustrating first conductive layer 111. The configuration of second conductive layer 112 is the same as the configuration of first conductive layer 111. Therefore, hereinafter, only first conductive layer 111 will be described in detail as a representative example.

In the conventional power storage device, when the insulating support layer is bent, the conductive conductor may not be flexible enough to follow the insulating support layer. Specifically, when the conductive layer is bent together with the insulating support layer, since a gap is generated between metal particles constituting the conductive layer, a crack may be formed on the conductive layer. Thus, the insulating support layer is exposed from the crack. Therefore, gas may permeate into the exposed organic support layer, which causes the organic support layer to expand or contract.

Therefore, in the present embodiment, first conductive layer 111 is formed of flaky metal powder (flaky metal particles) 113. Specifically, first conductive layer 111 is formed by stacking flaky metal powder 113. Flaky metal powder 113 is formed of, for example, aluminum particles.

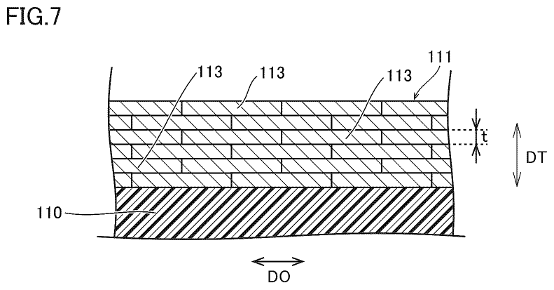

The flaky metal powder refers to such a metal particle that has an aspect ratio larger than that of normal metal powder (hereinafter, referred to as the non-flaky metal powder). In the present specification, the aspect ratio is defined as a value obtained by dividing the maximum value of a diameter r (the vertical length in FIG. 6) of each metal powder by the maximum value of a thickness t of each metal powder (FIG. 7) in a plan view. Since the non-flaky metal powder is substantially spherical, the aspect ratio thereof is substantially 1. Each of the maximum value and the minimum value (the horizontal length in FIG. 6) of the diameter r of flaky metal powder 113 is several tens of micrometers (μm). The thickness t of flaky metal powder 113 is several micrometers (μm). Therefore, the thickness of flaky metal powder 113 may be greater than 1 (for example, 10). The diameter of the non-flaky metal powder is several nanometers (nm).

FIG. 7 is a schematic cross-sectional view illustrating first conductive layer 111 and insulating support layer 110. In FIG. 7, the right-left direction is defined as the orthogonal direction DO, but the right-left direction may be a direction orthogonal to both the orthogonal direction DO and the thickness direction DT (in other words, the winding direction of electrode assembly 10).

As illustrated in FIG. 7, flaky metal powder 113 is formed of tabular particles. Therefore, when first electrode 10A is bent, even if a gap is formed between particles of flake metal powder 113 adjacent to each other in a direction intersecting (orthogonal to) the stacking direction (for example, the orthogonal direction DO), the gap is easily covered by particles of flake metal powder 113 stacked over each other in flake metal powder 113. As a result, it is possible to prevent insulating support layer 110 from being exposed from a crack formed on first conductive layer 111.

Thus, it is possible to prevent gas from permeating into insulating support layer 110, which causes insulating support layer 110 to expand or contract. As a result, it is possible to prevent first conductive layer 111 from being peeled off (detached) due to the permeation of gas between insulating support layer 110 and first conductive layer 111.

As illustrated in FIG. 7, the particles of flaky metal powder 113 adjacent to each other in the stacking direction (thickness direction DT) are more likely to be arranged so that their positions are offset from each other in a direction intersecting (orthogonal to) the stacking direction (the orthogonal direction DO in FIG. 7) than the non-flaky metal powder. Thus, it is difficult for a pinhole to be formed in first conductive layer 111.

### Manufacturing Method of Power Storage Cell

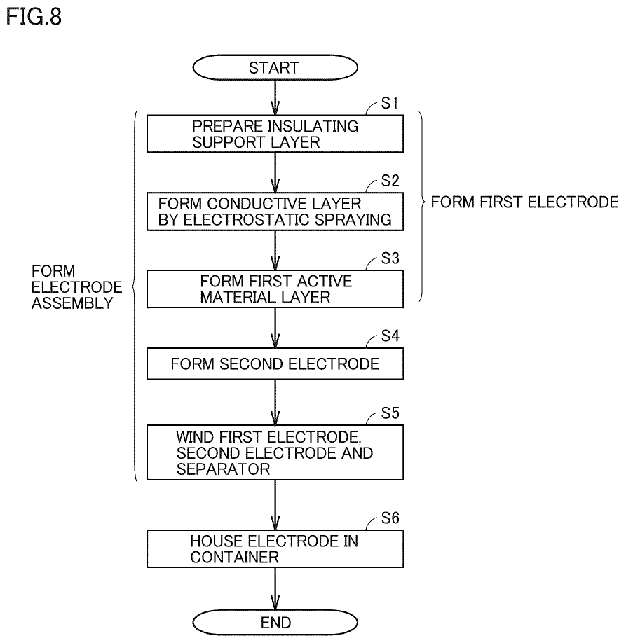

FIG. 8 is a flowchart illustrating an example manufacturing method of power storage cell 100.

In step S1, insulating support layer 110 is prepared. In step S1, a surface cleaning may be performed on insulating support layer 110. The surface cleaning may include, for example, at least one of a plasma treatment, a corona treatment, a UV treatment, an electrostatic removal treatment, an adhesive roll treatment, and a solvent treatment.

In step S2, first conductive layer 111 and second conductive layer 112 are formed on insulating support layer 110. In step S3, inner active material layer 121A is formed on first conductive layer 111, and outer active material layer 122A is formed on second conductive layer 112. Steps S1 to S3 are included in the process of forming first electrode 10A.

In step S4, second electrode 10B is formed. In step S5, first electrode 10A, second electrode 10B and separator 10C are wound together. Steps S1 to S5 are included in the process of forming electrode assembly 10.

In step S6, electrode assembly 10 formed by the winding in step S5 is housed in case 20.

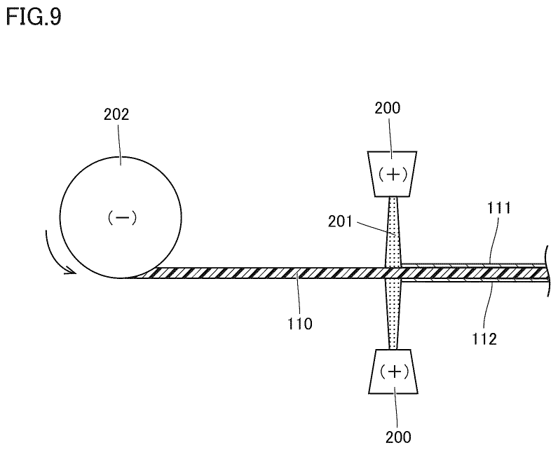

FIG. 9 is a diagram illustrating processes in step S2 of FIG. 8. In step S2, first conductive layer 111 and second conductive layer 112 are formed by electrostatic spraying. The electrostatic spraying in step S2 is performed in an atmospheric environment.

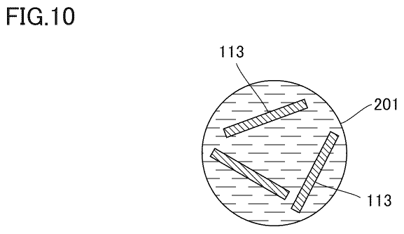

Specifically, coating particles 201 (FIG. 10) containing flaky metal powder 113 (FIG. 10) are sprayed from a positively charged electrostatic spray gun 200 onto both surfaces of insulating support layer 110. Thus, first conductive layer 111 and second conductive layer 112 are formed by stacking flaky metal powder 113 on both surfaces of insulating support layer 110.

Insulating support layer 110 is fed from a negatively charged roller 202 to pass through a region where coating particles 201 are sprayed by electrostatic spray gun 200. Therefore, insulating support layer 110 is negatively charged. As a result, coating particles 201 are sprayed from the positively charged electrostatic spray gun 200 onto the negatively charged insulating support layer 110.

Since coating particles 201 are electrostatically attracted toward insulating support layer 110, it is possible to prevent the moving speed of coating particles 201 from decreasing while coating particles 201 move from electrostatic spray gun 200 to insulating support layer 110. As a result, coating particles 201 are likely to collapse and spread on both surfaces of insulating support layer 110. Accordingly, flaky metal powder 113 can be easily oriented along both surfaces of insulating support layer 110. In FIG. 9, (+) means positively charged, and (−) means negatively charged.

Flaky metal powder 113 may be formed by pulverizing a metal foil. Alternatively, the flake metal powder may be formed by rolling, in the pulverizing step, spherical particles which are prepared by an atomization method as precursors.

In the embodiment described above, each of first conductive layer 111 and second conductive layer 112 formed on insulating support layer 110 is formed of flaky metal powder 113. Thus, a conductive layer can be formed in such a manner that the particles of flaky metal powders 113 are alternately stacked. As a result, the gap between particles of flaky metal powders 113 adjacent to each other can be covered by particles of flaky metal powders 113 stacked over each other in flaky metal powder 113. This can prevent insulating support layer 110 from being exposed.

In the embodiment described above, in first electrode 10A constituting the wound-type electrode assembly 10, first conductive layer 111 and second conductive layer 112 are disposed on the inner surface and the outer surface of insulating support layer 110, respectively. Since electrode assembly 10 is a wound-type electrode assembly, bending stress is likely to be applied to each of first conductive layer 111 and second conductive layer 112. Therefore, a gap is likely to be formed between adjacent particles of flake metal powder 113. Therefore, flaky metal powder 113 is particularly effective in preventing insulating support layer 110 of the wound-type electrode assembly 10 from being exposed.

### Modification

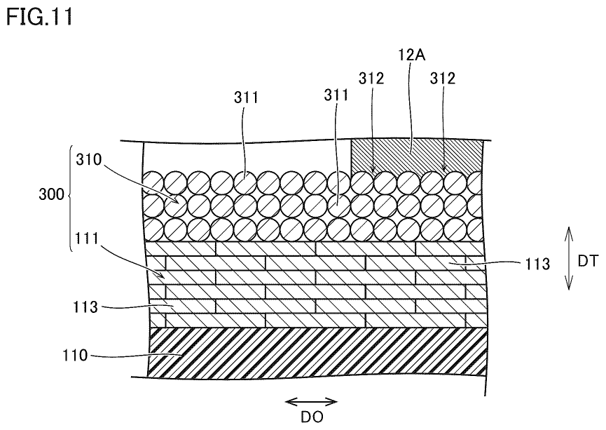

In the embodiment described above, it is described that the conductive layer formed on insulating support layer 110 is formed of only flaky metal powder 113, but the present disclosure is not limited thereto. In the example illustrated in FIG. 11, a conductive layer 300 is formed on insulating support layer 110 by stacking a conductive layer 111 and a conductive layer 310. Conductive layer 310 is arranged on the opposite side of insulating support layer 110 with respect to conductive layer 111. Conductive layer 310 is formed of non-flaky metal powder 311. As described above, the aspect ratio of the non-flaky metal powder 311 is smaller than the aspect ratio of flaky metal powder 113. Note that the structure on the side of conductive layer 112 may be configured in the same manner as that in FIG. 11. In the example illustrated in FIG. 11, conductive layer 111 and conductive layer 310 are examples of a “first metal layer” and a “second metal layer” of the present disclosure, respectively.

Since the non-flaky metal powder 311 is formed in a spherical shape, a recess 312 is formed on the outer surface of non-flaky metal powder 311 between adjacent particles. Thus, first active material layer 12A enters recess 312, and thereby first active material layer 12A can be more stably fixed to conductive layer 300 due to the anchor effect.

The conductive layer 300 may be formed in such a manner that conductive layer 111 is firstly formed on insulating support layer 110 by electrostatic spraying or the like, and then conductive layer 310 is formed on conductive layer 111 by vapor deposition, sputtering or the like.

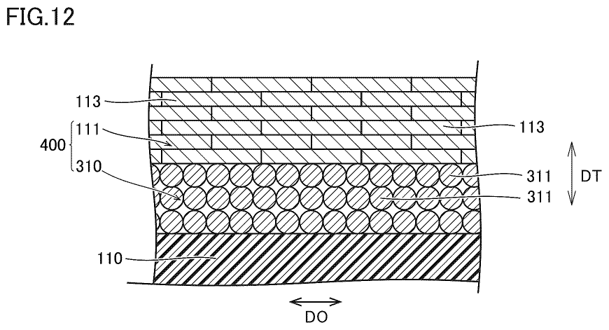

In the example illustrated in FIG. 12, a conductive layer 400 is formed on insulating support layer 110 by stacking conductive layer 111 and conductive layer 310. Conductive layer 310 is located closer to insulating support layer 110 than conductive layer 111. Note that the structure on the side of conductive layer 112 may be configured in the same manner as that in FIG. 12.

Since flaky metal powder 113 extends along insulating support layer 110, conductive layer 111 has higher bending rigidity than conductive layer 310. Therefore, conductive layer 310 having relatively low bending rigidity is disposed near insulating support layer 110, and conductive layer 310 is covered with conductive layer 111. Accordingly, insulating support layer 110 can be easily bent, and the crack formed on conductive layer 310 can be covered with conductive layer 111 (flaky metal powder 113).

Note that the conductive layer 400 may be formed in such a manner that conductive layer 310 is firstly formed on insulating support layer 110 by vapor deposition, sputtering or the like, and then conductive layer 111 is formed on conductive layer 310 by electrostatic spraying or the like.

Although it is described that first conductive layer 111 and second conductive layer 112 have the same configuration in the above embodiment, the present disclosure is not limited thereto. The conductive layer on one side may have a configuration in any of FIGS. 7, 11 and 12, and the conductive layer on the other side may have a configuration different from that of the conductive layer on one side of FIGS. 7, 11 and 12. Further, a conductive layer may be formed only on one surface of insulating support layer 110. Furthermore, a conductive layer may be formed of flaky metal powder on an end surface of insulating support layer 110 in the Z direction (orthogonal direction DO).

Although it is described that the conductive layer is formed by electrostatic spraying using an electrostatic spray gun in the above embodiment, the present disclosure is not limited thereto. For example, a coating material containing flake metal powder may be applied to insulating support layer 110 using a positively charged coating roller. Alternatively, insulating support layer 110 may be immersed in a coating material that contains flaky metal powder and is filled in a positively charged container.

Although it is described that first electrode 10A includes a conductive layer formed of flaky metal powder in the above embodiment, the present disclosure is not limited thereto. Instead of or in addition to first electrode 10A, second electrode 10B may include a conductive layer formed of flaky metal powder (for example, copper powder).

Although it is described that the conductive layer is formed by electrostatic spraying in the above embodiment, the present disclosure is not limited thereto. For example, the spray gun and the insulating support layer are not charged, and coating particles containing the flaky metal powder may be sprayed from the spray gun to the insulating support layer.

Although it is described that electrode assembly 10 is housed in case 20 in the above embodiment, the present disclosure is not limited thereto. For example, electrode assembly 10 may be housed (sealed) by using a laminate film. In this case, the laminate film is an example of a “container” of the present disclosure.

The configurations of the above embodiments and modifications may be combined with each other.

Although the embodiments of the present disclosure have been described, it should be understood that the embodiments disclosed herein are illustrative and non-restrictive in all respects. It is intended that the scope of the present disclosure is not limited to the description above but defined by the scope of the claims and encompasses all modifications equivalent in meaning and scope to the claims.

What is claimed is:

1. A power storage cell comprising:
an electrode assembly; and
a container that houses the electrode assembly, wherein
the electrode assembly includes an electrode sheet,
the electrode sheet includes an insulating support layer, and a conductive layer that is formed on the insulating support layer, and
the conductive layer is formed of flaky metal powder.

2. The power storage cell according to claim 1, wherein
the electrode assembly is a wound-type electrode assembly obtained by winding the electrode sheet around a winding axis, and
in the electrode sheet, the conductive layer is formed on at least one of an inner surface and an outer surface of the insulating support layer.

3. The power storage cell according to claim 1, wherein
the conductive layer includes a first metal layer and a second metal layer that are stacked,
the first metal layer is formed of the flaky metal powder,
the second metal layer is formed of non-flaky metal powder, and
an aspect ratio of the non-flaky metal powder is smaller than an aspect ratio of the flaky metal powder.

4. A manufacturing method of a power storage cell comprising:
forming an electrode assembly;
housing the electrode assembly in a container, wherein
the forming of the electrode assembly includes:
preparing an insulating support layer; and
forming a conductive layer by stacking flaky metal powder on the insulating support layer.

5. The manufacturing method of a power storage cell according to claim 4, wherein
in the forming of the conductive layer, the flaky metal powder is staked on the insulating support layer by electrostatic spraying.
